(19) United States
(12) Patent Application Publication
(10) Pub. No.: US 2022/0143517 A1
(43) Pub. Date: May 12, 2022

(54) Extended Reality Arm Stabilizer System and Method

(71) Applicant: Glow Worm LLC, Wallingford, CT (US)

(72) Inventor: Aaron Monikowski, Wallingford, CT (US)

(21) Appl. No.: 17/521,683

(22) Filed: Nov. 8, 2021

Related U.S. Application Data
(60) Provisional application No. 63/198,784, filed on Nov. 12, 2020.

(51) Int. Cl. A63F 13/98; A63F 13/245

(52) U.S. Cl. CPC A63F 13/98; A63F 13/837; A63F 13/245

(57) ABSTRACT

A system includes a third point contact frame comprising a vertical frame and a horizontal frame connected with mounting hardware, the third point contact frame having a positional lever connected to one end of the horizontal frame closest to the vertical frame, a user arm interface having a first end and a second end opposite one another and connected with a middle bar, the user arm interface connected to the third point contact frame, and a user attachment system configured to be worn by a user comprising a strap mounting bracket that is attached to the vertical frame of the third point contact frame, a strap pathed through a strap adjuster, the strap mounting bracket, and the positional lever.

### CROSS-REFERENCE TO RELATED APPLICATION

This application claims the benefit of U.S. Provisional Application No. 63/198,784 filed Nov. 12, 2020, entitled “Arm Stabilizer for Virtual Reality,” the entire contents of which is incorporated herein by reference.

### FIELD

The present disclosure is directed generally to an extended reality arm stabilizer system or device.

### BACKGROUND

Extended reality (XR) may include Virtual Reality (VR), Mixed Reality (MR), and Augmented Reality (AR) and can digitally portray many environments for the user and enable simulations of shooting, driving, piloting, and other activities. Computer software and hardware renders the digital environments and presents them on a screen worn on the head of the user or viewed by the user and tracked to user movement. The user interacts with these virtual environments with handheld controllers, their hands, or with specialized controllers. Although these controllers are suitable, they lack some functions for certain activities.

XR users have complained that long distance target shooting is made difficult when using handheld controllers. As an example, aim sway can be caused by instability of the shoulder joint. The controllers can be disconnected from one another. In comparison, a rifle would feel like a connected object when steadying aim. The problem stems from disconnected points of contact compared to real life marksmanship.

It is with these issues in mind, among others, that various aspects of the disclosure were conceived.

### SUMMARY

The present disclosure is directed to an extended reality arm stabilizer system and method. A system may include a first component or unit that receives a user's arm, a second component or unit that makes contact with a user in a location such as their shoulder, chest, bicep, forearm, abdomen, hip, or thigh, and a third component or unit that is configured to attach to the user's body, for example, over each shoulder and behind the back. The first component or unit may be a user arm interface, the second component or unit may be a third point of contact frame, and the third component or unit may be a user attachment system. The system may be utilized by the user during use of an XR headset and/or hardware to allow the user to stabilize arm movement and provide haptic sensation while utilizing an XR software application executed by the XR headset and/or associated hardware.

In one example, a system may include a third point contact frame comprising a vertical frame and a horizontal frame connected with mounting hardware, the third point contact frame having a positional lever connected to one end of the horizontal frame closest to the vertical frame, a user arm interface having a first end and a second end opposite one another and connected with a middle bar, the user arm interface connected to the third point contact frame, and a user attachment system configured to be worn by a user comprising a strap mounting bracket that is attached to the vertical frame of the third point contact frame, a strap pathed through a strap adjuster, the strap mounting bracket, and the positional lever.

In another example, a method may include attaching a user attachment system to a user, the user attachment system comprising a strap mounting bracket that is attached to a vertical frame of a third point contact frame, a strap pathed through a strap adjuster, the strap mounting bracket, and a positional lever, and receiving an arm of the user into a user arm interface having a first end and a second end opposite one another and connected with a middle bar, the user arm interface connected to a third point contact frame comprising a vertical frame and a horizontal frame connected with mounting hardware, and a positional lever connected to one end of the horizontal frame closest to the vertical frame.

In another example, an arm stabilizer device for extended reality may include a third point contact frame comprising a vertical frame and a horizontal frame connected with mounting hardware, the third point contact frame having a positional lever connected to one end of the horizontal frame closest to the vertical frame, a user arm interface having a first end and a second end opposite one another and connected with a middle bar, the user arm interface connected to the third point contact frame, and a user attachment system configured to be worn by a user comprising a strap mounting bracket that is attached to the vertical frame of the third point contact frame, a strap pathed through a strap adjuster, the strap mounting bracket, and the positional lever.

These and other aspects, features, and benefits of the present disclosure will become apparent from the following detailed written description of the preferred embodiments and aspects taken in conjunction with the following drawings, although variations and modifications thereto may be effected without departing from the spirit and scope of the novel concepts of the disclosure.

### BRIEF DESCRIPTION OF THE DRAWINGS

The accompanying drawings illustrate embodiments and/or aspects of the disclosure and, together with the written description, serve to explain the principles of the disclosure. Wherever possible, the same reference numbers are used throughout the drawings to refer to the same or like elements of an embodiment, and wherein:

FIGS. 1A-1G show diagrams of example conventional devices according to an example of the instant disclosure.

FIG. 2A is a block diagram of an extended reality arm stabilizer system according to an example of the instant disclosure.

FIG. 2B is a diagram showing the extended reality arm stabilizer system according to an example of the instant disclosure.

FIG. 2C shows another diagram of the extended reality arm stabilizer system according to an example of the instant disclosure.

FIG. 3 is a diagram showing a photographic view of the extended reality arm stabilizer system according to an example of the instant disclosure.

FIG. 4A is another photographic view of the extended reality arm stabilizer system diagram according to an example of the instant disclosure.

FIG. 4B is a back photographic view of the extended reality arm stabilizer system according to an example of the instant disclosure.

FIG. 5A is a side photographic view of the extended reality arm stabilizer system according to an example of the instant disclosure.

FIG. 5B is another side photographic view of the extended reality arm stabilizer system that is opposite the view of FIG. 5A.

FIG. 6A is a flowchart of a method of using a conventional device according to an example of the instant disclosure.

FIG. 6B is a flowchart of a method of using the extended reality arm stabilizer system according to an example of the instant disclosure.

FIGS. 7A-7C show a user using the extended reality arm stabilizer system according to an example of the instant disclosure.

FIG. 8 shows an example of a system for implementing certain aspects of the present technology.

### DETAILED DESCRIPTION

The present invention is more fully described below with reference to the accompanying figures. The following description is exemplary in that several embodiments are described (e.g., by use of the terms “preferably,” “for example,” or “in one embodiment”); however, such should not be viewed as limiting or as setting forth the only embodiments of the present invention, as the invention encompasses other embodiments not specifically recited in this description, including alternatives, modifications, and equivalents within the spirit and scope of the invention. Further, the use of the terms “invention,” “present invention,” “embodiment,” and similar terms throughout the description are used broadly and not intended to mean that the invention requires, or is limited to, any particular aspect being described or that such description is the only manner in which the invention may be made or used. Additionally, the invention may be described in the context of specific applications; however, the invention may be used in a variety of applications not specifically described.

The embodiment(s) described, and references in the specification to “one embodiment”, “an embodiment”, “an example embodiment”, etc., indicate that the embodiment(s) described may include a particular feature, structure, or characteristic. Such phrases are not necessarily referring to the same embodiment. When a particular feature, structure, or characteristic is described in connection with an embodiment, persons skilled in the art may effect such feature, structure, or characteristic in connection with other embodiments whether or not explicitly described.

In the several figures, like reference numerals may be used for like elements having like functions even in different drawings. The embodiments described, and their detailed construction and elements, are merely provided to assist in a comprehensive understanding of the invention. Thus, it is apparent that the present invention can be carried out in a variety of ways, and does not require any of the specific features described herein. Also, well-known functions or constructions are not described in detail since they would obscure the invention with unnecessary detail. Any signal arrows in the drawings/figures should be considered only as exemplary, and not limiting, unless otherwise specifically noted. Further, the description is not to be taken in a limiting sense, but is made merely for the purpose of illustrating the general principles of the invention, since the scope of the invention is best defined by the appended claims.

It will be understood that, although the terms “first,” “second,” etc. may be used herein to describe various elements, these elements should not be limited by these terms. These terms are only used to distinguish one element from another. Purely as a non-limiting example, a first element could be termed a second element, and, similarly, a second element could be termed a first element, without departing from the scope of example embodiments. As used herein, the term “and/or” includes any and all combinations of one or more of the associated listed items. As used herein, the singular forms “a”, “an,” and “the” are intended to include the plural forms as well, unless the context clearly indicates otherwise. It should also be noted that, in some alternative implementations, the functions and/or acts noted may occur out of the order as represented in at least one of the several figures. Purely as a non-limiting example, two figures shown in succession may in fact be executed substantially concurrently or may sometimes be executed in the reverse order, depending upon the functionality and/or acts described or depicted.

It should also be noted that in some alternative implementations, the functions/acts noted may occur out of the order noted in the figures. For example, two figures shown in succession may in fact be executed substantially concurrently or may sometimes be executed in the reverse order, depending upon the functionality/acts involved.

Conditional language, such as, among others, “can,” “could,” “might,” or “may,” unless specifically stated otherwise, or otherwise understood within the context as used, is generally intended to convey that certain embodiments include, while other embodiments do not include, certain features, elements and/or steps. Thus, such conditional language is not generally intended to imply that features, elements and/or steps are in any way required for one or more embodiments or that one or more embodiments necessarily include logic for deciding, with or without user input or prompting, whether these features, elements and/or steps are included or are to be performed in any particular embodiment.

Aspects of a system and method for extended reality arm stabilization includes a first component or unit that receives a user's arm, a second component or unit that makes contact with a user in a location such as their shoulder, chest, bicep, forearm, abdomen, hip, or thigh, and a third component or unit that is configured to attach to the user's body such as over each shoulder and behind the back. The first component or unit may be a user arm interface, the second component or unit may be a third point of contact frame, and the third component or unit may be a user attachment system. The system may be utilized by the user during use of an XR headset and/or hardware to allow the user to stabilize arm movement and provide haptic sensation while playing an XR software application executed by the XR headset and/or associated hardware.

Extended reality (XR) may include Virtual Reality (VR), Mixed Reality (MR), and Augmented Reality (AR) and can digitally portray many environments for the user and enable simulations of shooting, driving, piloting, and other activities. Computer software and hardware renders the digital environments and presents them on a screen worn on the head of the user or viewed by the user and tracked to user movement. The user interacts with these virtual environments with handheld controllers, their hands, or with specialized controllers. Although these controllers are suitable, they lack some functions for certain activities.

XR users have complained that long distance target shooting is made difficult when using handheld controllers. One reason is aim sway caused by instability of the shoulder joint. Another reason is that the controllers are disconnected. In comparison, a rifle would feel like a connected object when steadying aim. The problem stems from disconnected points of contact compared to real life marksmanship. As an example, there may be three points of contact used in real life aiming. These three points of contact are also applicable to an extended reality controller and environment.

The off hand is considered the first point of contact and usually supports the front of a two handed firearm. The trigger hand can be the second point of contact and holds the grip next to the trigger. A third point of contact may allow for aim stabilization and can connect to a third point on the body or an exterior fixture. For example, the third point of contact may be associated with a shoulder stock in, on, or approximate the shoulder pocket of a person or a rifle resting on a table. These third points of contact help with stabilizing aim over long distances.

In one example, the system includes a third point contact frame comprising a vertical frame and a horizontal frame connected with mounting hardware. The third point contact frame may have a positional lever mounted or connected to one end of the horizontal frame closest to the vertical frame. In addition, a user arm interface may have a first end and a second end opposite one another and connected with a middle bar. The user arm interface may be mounted to the third point contact frame. In addition, the system includes a user attachment system configured to be worn by a user including a strap mounting bracket that is attached to the vertical frame of the third point contact frame, a strap pathed through a strap adjuster, an optional a rear strap conduit, the strap mounting bracket, the positional lever, and an optional strap slide. The system may include user arm interface padding that encloses the user arm interface and strap padding attached to the strap. The horizontal frame may be aluminum and the positional lever may be polylactic acid plastic. The user arm interface may be configured to receive an arm of the user. The user attachment system may be configured to form a first loop to be worn on a first shoulder of the user and form a second loop to be worn on a second shoulder of the user.

The user arm interface may be a first user arm interface and the system may include a second user arm interface having a first end and a second end opposite one another and connected with a middle bar, the second user arm interface mounted to the third point contact frame.

The third point of contact frame is configured to contact at least one of a bicep of the user, a shoulder of the user, a torso of the user, a core of the user, a hip of the user, a back of the user, and a leg of the user. Additionally, the system may be configured to fit the user attachment device to the user by using the strap adjuster. The strap adjuster may be one of a zipper, a button, a snap, a hook and loop fastener, a swivel joint, and a rib or slot-slide enclosure. The system may be configured for use with an extended reality controller. The system may include at least one processor to store a user profile in memory for the system. The user profile may be associated with pre-determined positional preferences. Examples may include positional preferences for steering wheel, fishing pole, rifle, shotgun, and other activities simulated in the virtual environments.

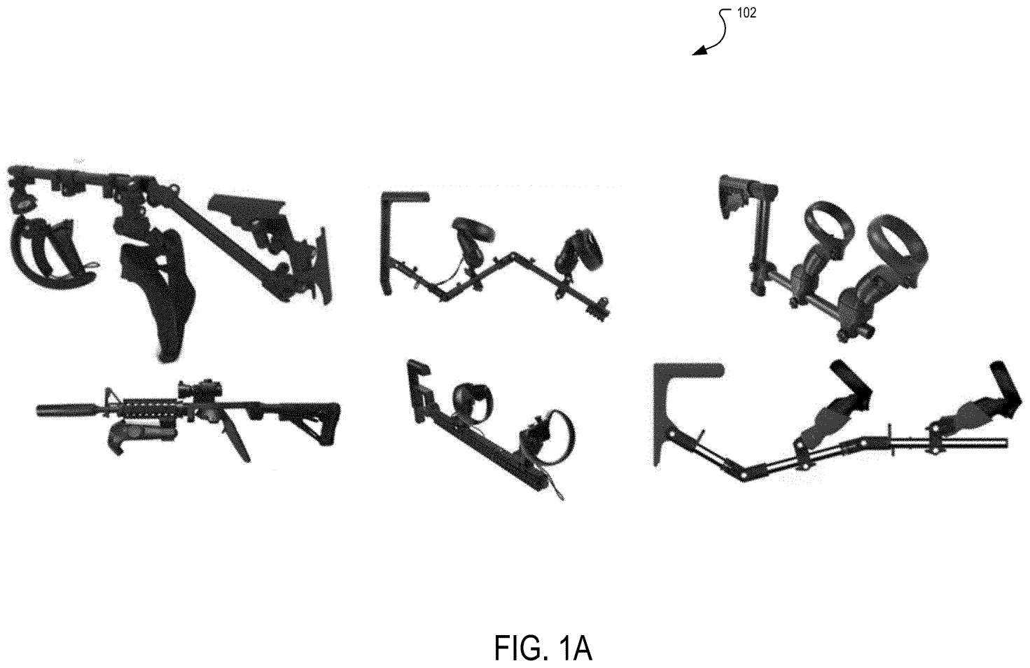

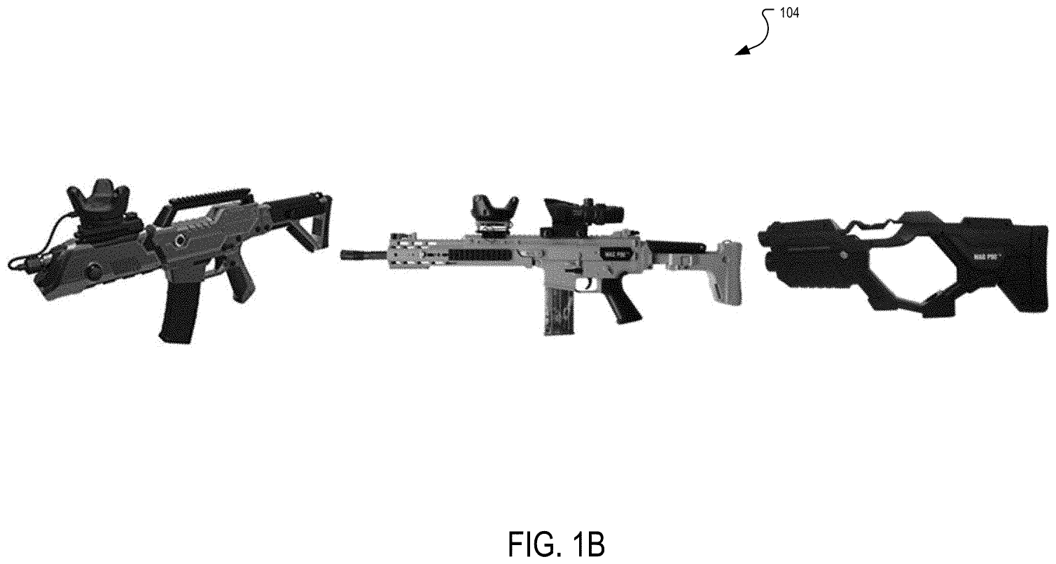

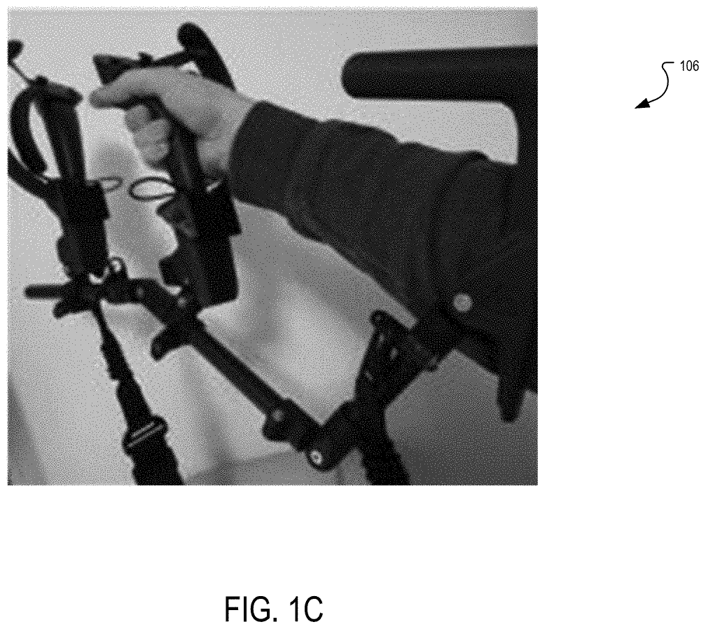

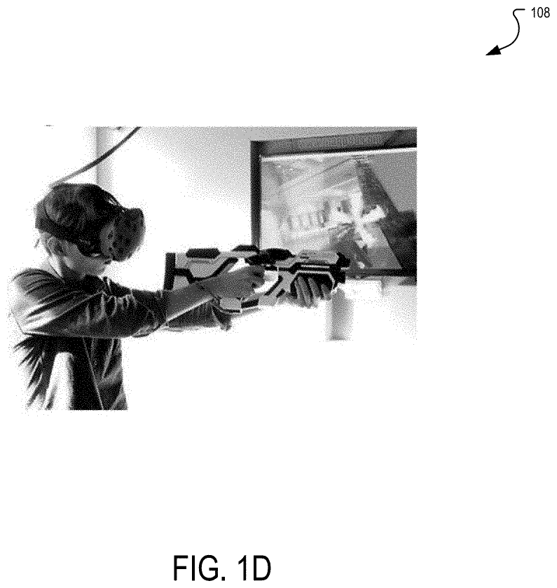

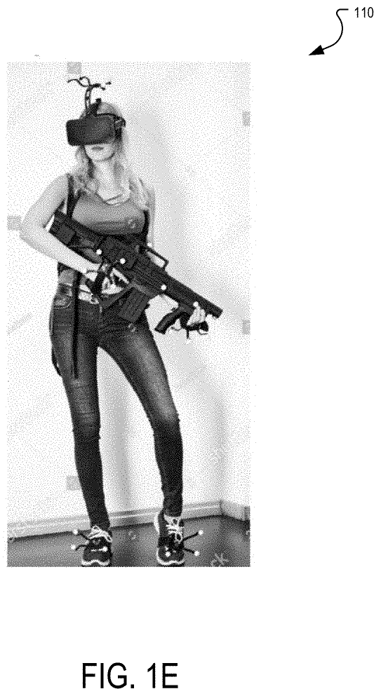

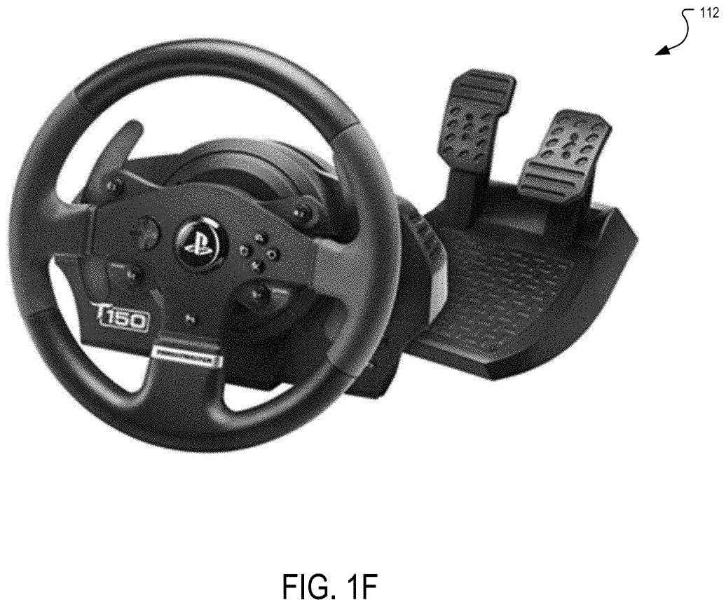

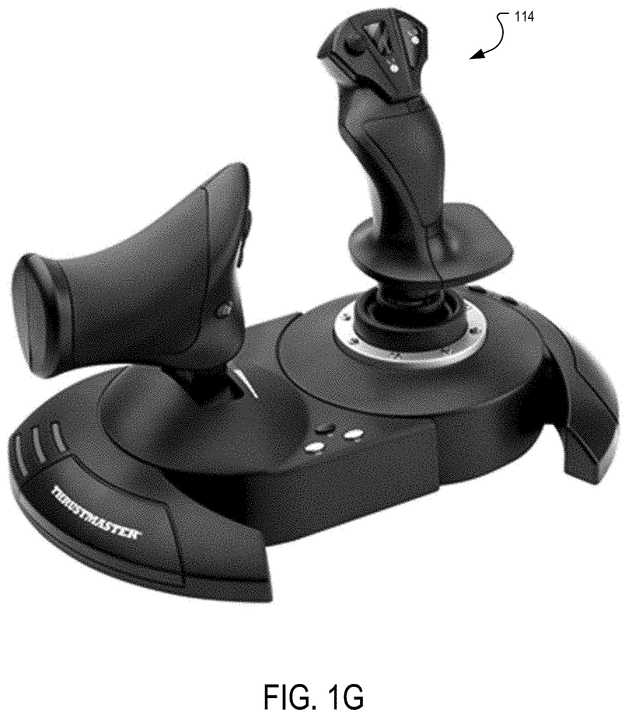

As shown in FIGS. 1A and 1B, conventional solutions 102 and 104 have attempted to provide third points of contact with XR gun stocks and XR guns or blasters. XR gun stocks use controller specific adapters that fix the controllers to external hardware. XR guns can replace the controller entirely with a shape of a firearm. There are problems with these approaches that are solved with the arm stabilizer system.

XR gun stocks are limited because they require controller specific adapters. These adapters may not be available for all controller types. If a user changes the design of their controllers, they may not be able to use their XR gun stock. The arm stabilizer system discussed herein may not have to utilize controller specific adapters and can be used with whatever device the user has in their hand or is using.

XR gun stocks also limit off hand movement because the controller is attached. This makes it cumbersome to do common actions like reloading, pumping a shot gun, interacting with a XR object, etc. Some XR gun stock manufacturers use magnets to make the controllers detachable. Unfortunately, this can require the user to pull with excess of 10-30 pounds of force every time they want to remove the controller from the XR gun stock. In addition, replacement of the controller via magnets is clunky because the user cannot see the physical location and the magnetic attraction is limited to very close range. The arm stabilizer system does not fix the controllers or use magnets and thus allows free range of motion for both controllers without additional effort to separate. Also, the arm stabilizer system is easier to use because of greater haptic sensation.

XR gun stocks can fail in their ability to allow for a third point of contact and simultaneous alignment of the user's dominant eye for aiming. Many XR gun stocks are fixed in rigid positions. In some cases, the digital firearm cannot be aligned with the user's eye because the XR headset may collide with the XR gun stock. In these cases, the user must choose between stability or eye alignment. FIG. 1D shows such an example 108.

Some XR gun stock designs allow for limited adjustments. However, these adjustments are done mechanically and may require the user to remove the headset and use a tool. This can disrupt or break flow and immersion. XR gun stock users complain that they have to calibrate the angle of their controllers when switching weapons within the same game. This reduces fluidity, is time consuming, and reduces user options.

In contrast, the arm stabilizer system described herein has easier adjustment through natural arm movement and can reposition weapon sights with the user's dominant eye while maintaining a third point of contact. The arm stabilizer system allows for any combination of dominant hand and eye combinations. For instance, a user can be right handed and left eye dominant and still rapidly align their eye with the XR gun sight and maintain contact with their right shoulder. This is because the design of the system does not affect the controllers and allows the user to position every joint of their arm to translate into controller alignments in XR. Therefore, the user of the arm stabilizer system can fluidly change their desired in-game weapon and quickly line up sights and aim steadier.

XR gun stocks also decrease immersion. For example, as shown in FIG. 1E, the user is holding what feels like a rifle in this example 110, but their XR avatar may be playing a piano or other simulated activities that would not involve holding a rifle.

XR gun stock users also complain about limited range of motion of their dominant arm. The XR gun stocks may protrude beyond their normal length of arm extension and may collide with objects outside their play area. FIG. 1C shows an example 106. Also, accompanying slings may prevent the user from fully extending their dominant arm. This limitation complicates throwing objects with a full arm extension and/or shoulder rotation.

Overall, XR gun stocks may reduce the controller ergonomics, weight distribution, and range of motion.

The arm stabilizer system intuitively rests on the user and does not add to the length of the user's outstretched arms or prevent full arm extension and rotation. Rather, the arm stabilizer system operates on-demand and independently of the controllers.

XR guns and devices have the same problems as XR gun stocks, but are also limited by software compatibility. VIVE Trackers, as shown in two of the three examples 104 in FIG. 1B, would not be compatible with inside out tracking mechanisms. In other words, the XR guns may not work with all XR technologies or hardware setups.

The arm stabilizer system is designed to attach and interact with the human body. As a result, the chosen XR technology or hardware does not affect usability.

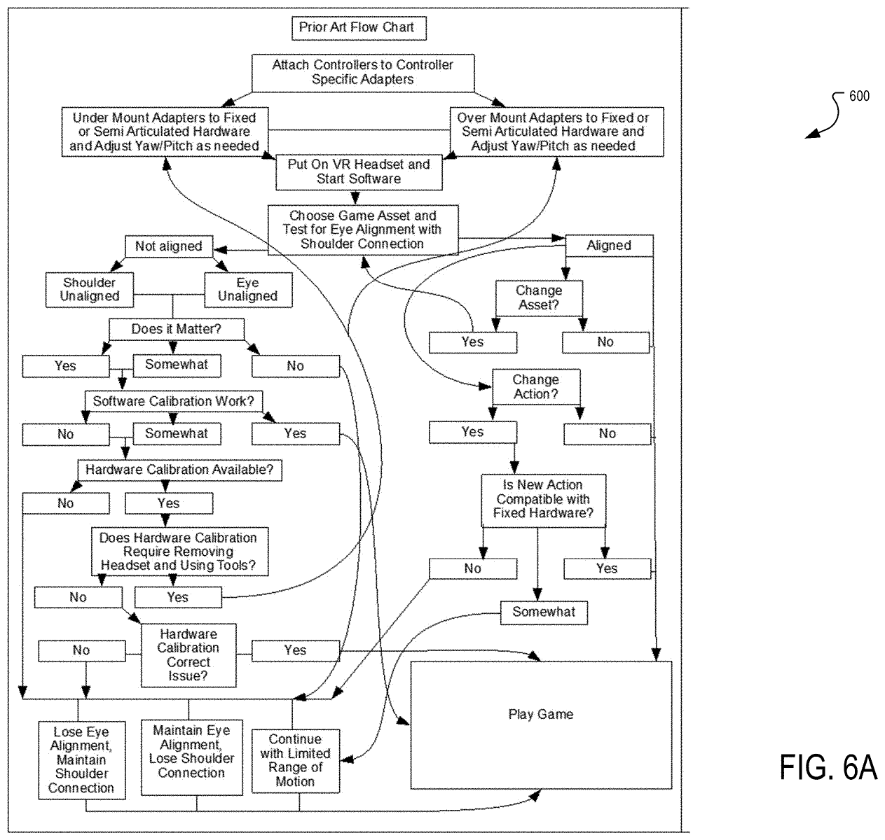

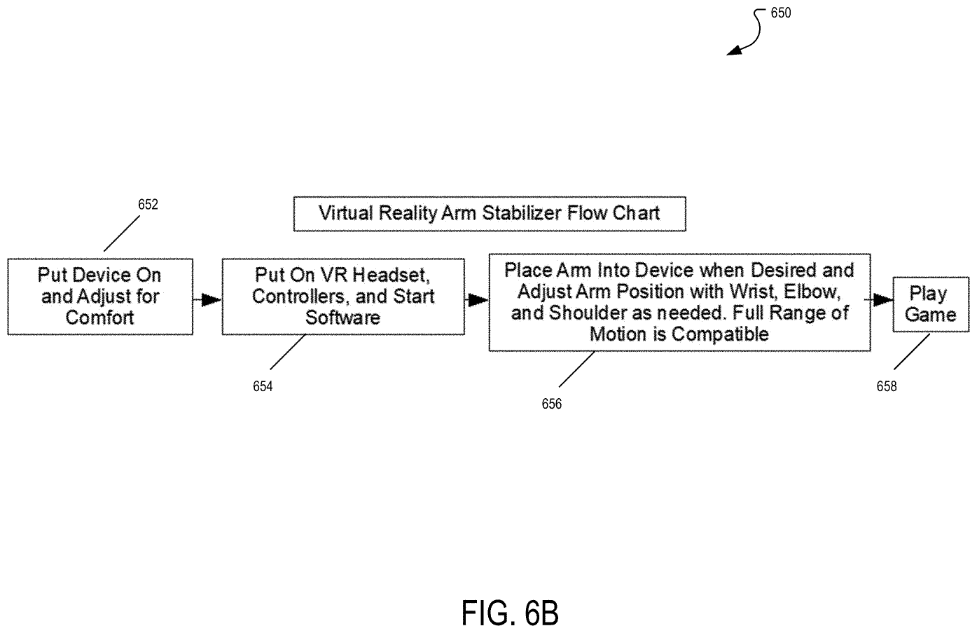

XR gun stocks and XR guns have tradeoffs between arm stability, eye alignment, immersion, full range of motion, and hardware/software compatibility. FIG. 6A shows a flow chart and is described below associated with conventional solutions. These conventional solutions unfortunately include too many disadvantages associated with arm stability, eye alignment, immersion, range of motion, ease of use, and hardware/software compatibility.

Full controller replacements are also used to simulate driving and piloting. FIGS. 1F and 1G show examples of a steering wheel and pedal set up 112 and a Hand On Throttle And Stick 114, or “HOTAS” device. These devices are limited in scope because when used they cannot be easily repurposed with different XR simulations. A steering wheel controller may increase driving immersion while limiting immersion for non-driving actions.

The arm stabilizer system can also be used to increase immersion for driving and piloting. Two arm stabilizers can be used with additional variable length and angles to create positional arm rests that would support a user's arms when extended to a virtual steering wheel position. Further, positional arm rests can be configured that match the stick and throttle positions of different cockpit orientations. The advantage is that arm stabilizers could be used for some degree of aiming assistance, driving immersion, and piloting immersion instead of using three exclusively separate devices. Also, users would not have to spend time remapping controls to the specialized driving and flight controllers.

The area of the body and position of the device are user determined and controlled via natural arm gesture interactions. Increased spatial awareness may facilitate faster, intuitive, and natural responsiveness with the user and the device when immersed in a XR environment.

Therefore, the system or device may have one or more various advantages including ease of setup and use, improved weight distribution, broader hardware compatibility, fewer limitations associated with software compatibility, a greater sense of immersion, assisting in allowing a user to aim faster and steadier, ability to adjust quickly with arm gestures when switching between different XR objects, better spatial awareness for user interactions, the system does not affect the controllers, and the system does not limit arm extension or shoulder rotation, among others.

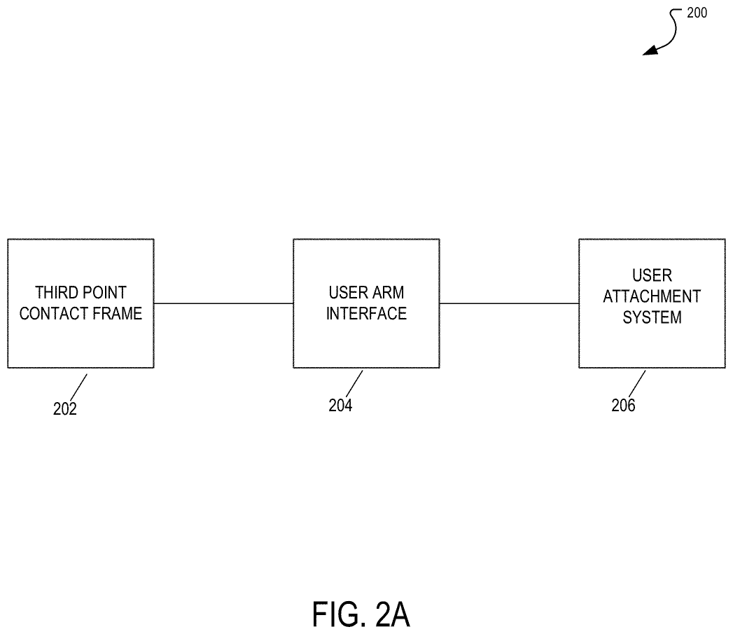

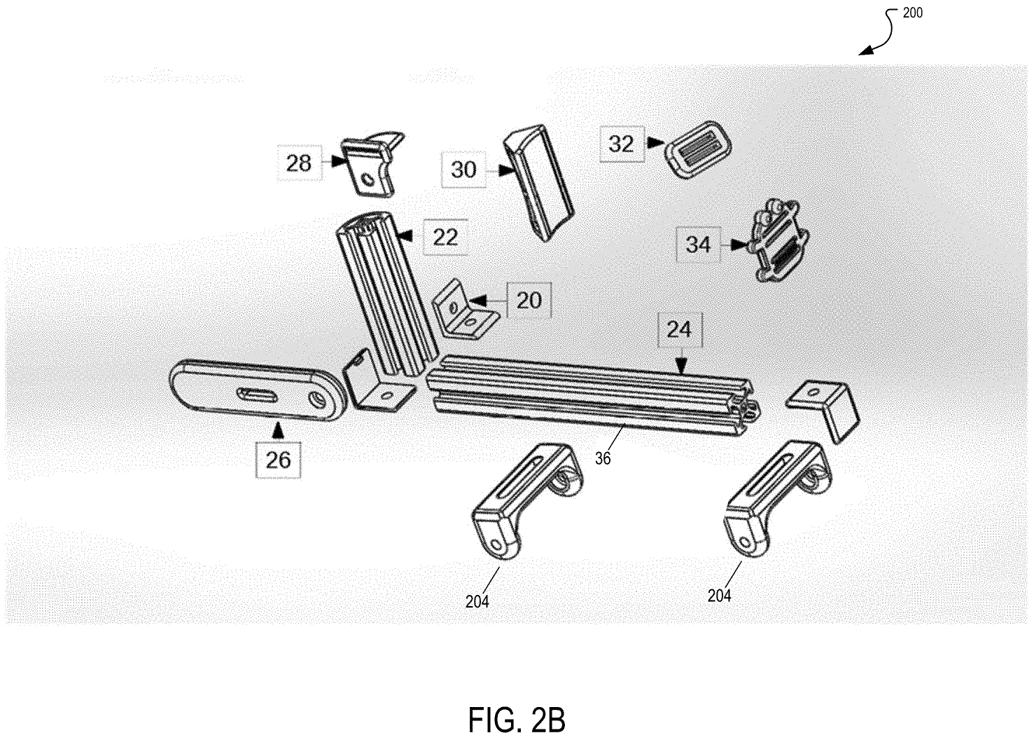

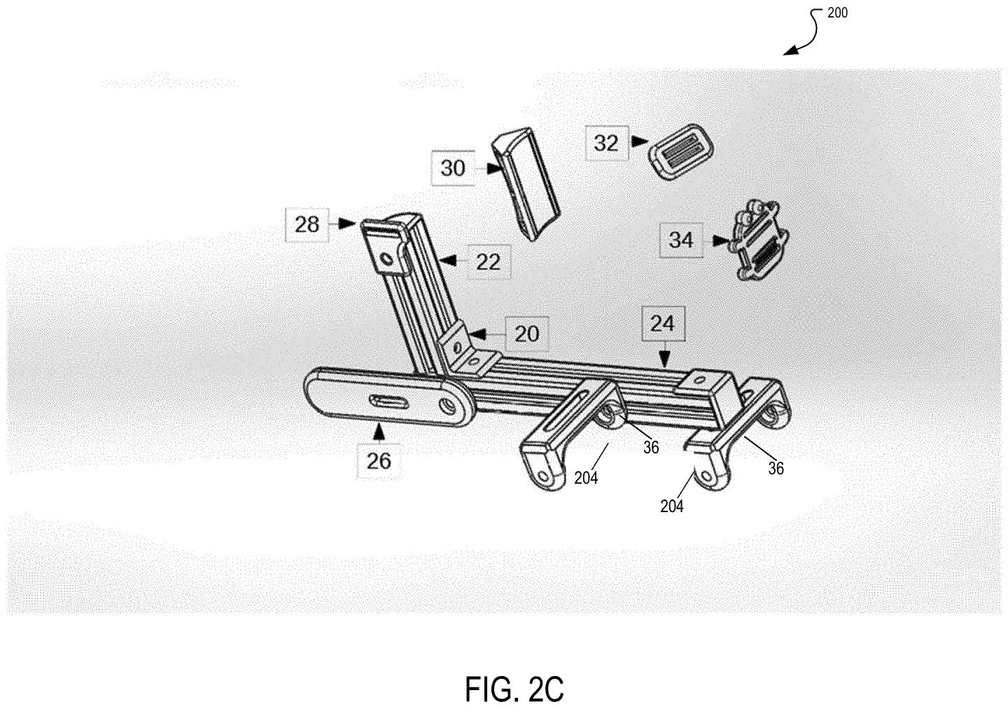

FIGS. 2A-2C show diagrams of an extended reality arm stabilizer system 200 according to an example of the instant disclosure. FIG. 2A is a block diagram of the extended reality arm stabilizer system 200 according to an example of the instant disclosure. As shown in FIG. 2A, the system 200 may include a third point contact frame 202, one or more user arm interfaces 204, and a user attachment system 206, among other components.

As shown in FIGS. 2B-2C, the system 200 may include the third point contact frame 202 that may include a bracket or mounting hardware 20 that is mounted or connected to a vertical frame 22 and horizontal frame 24. A positional lever 26 can be mounted to the end of the horizontal frame 24 closer to the vertical frame 22. As an example, the vertical frame 22 and the horizontal frame 24 can be aluminum extrusions and the positional lever 26 can be polylactic acid plastic. However, different materials, sizes, and interconnections can be used for all components.

The user arm interface 204 may be moved from one mount point 36 to another mount point 36 on the third point contact frame 202. FIGS. 2B-2C show that the mount point 36 may be over, under, or on either side of the horizontal frame 24. The user arm interface 204 may be positioned 36 across the axis of the horizontal 24 frame depending on user preference.

Additionally, the user arm interface 204 may be rotated or angled at a mount point 36 to the horizontal frame 24.

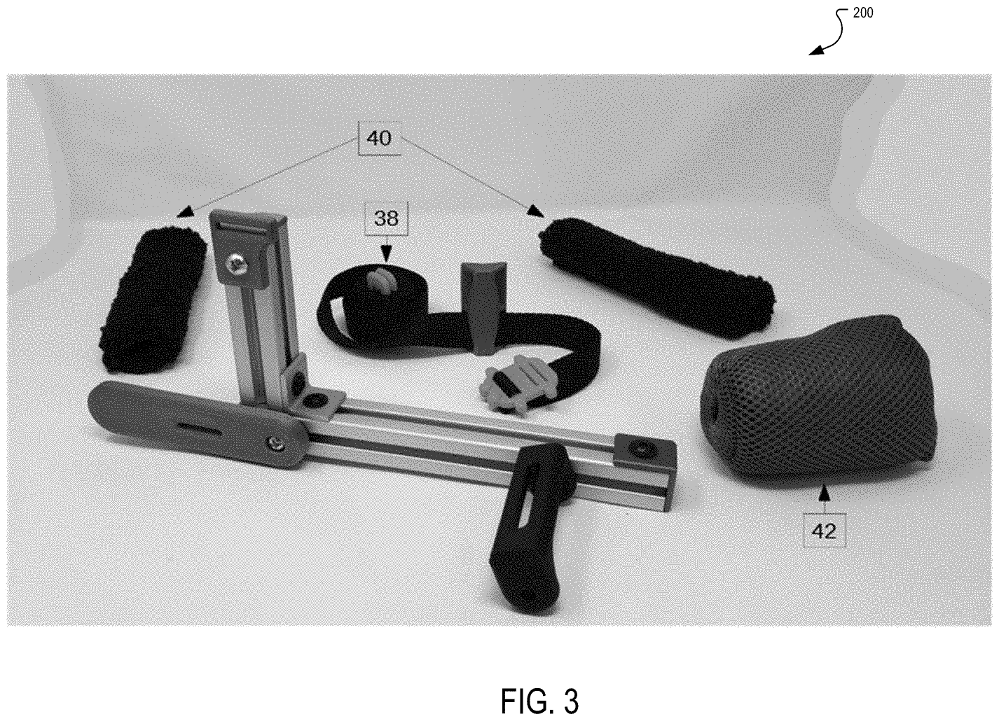

The extended reality arm stabilizer system 200 may include a user attachment system 206. As shown in FIGS. 2B and 2C, a strap mounting bracket 28 can be attached to the vertical frame 22. FIG. 3 shows that a strap 38 can be pathed through a strap adjuster 34, rear strap conduit 30, the strap mounting bracket 28, positional lever 26, and strap slide 32.

FIG. 3 also shows other components associated with the extended reality arm stabilizer system 200. Optional user arm interface padding 42 may enclose the user arm interface. Optional strap padding 40 may be affixed to the strap 38.

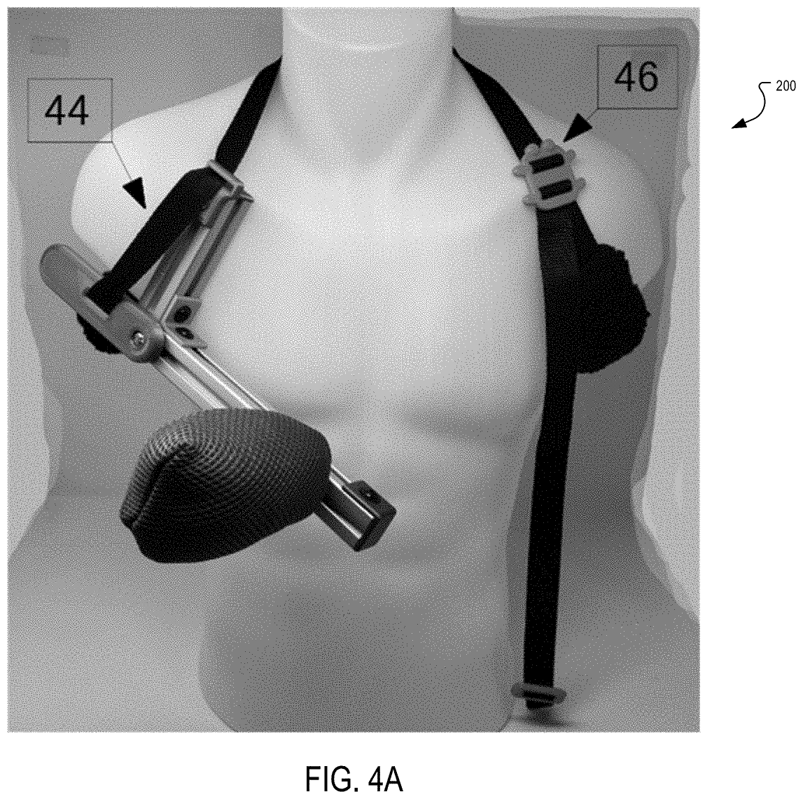

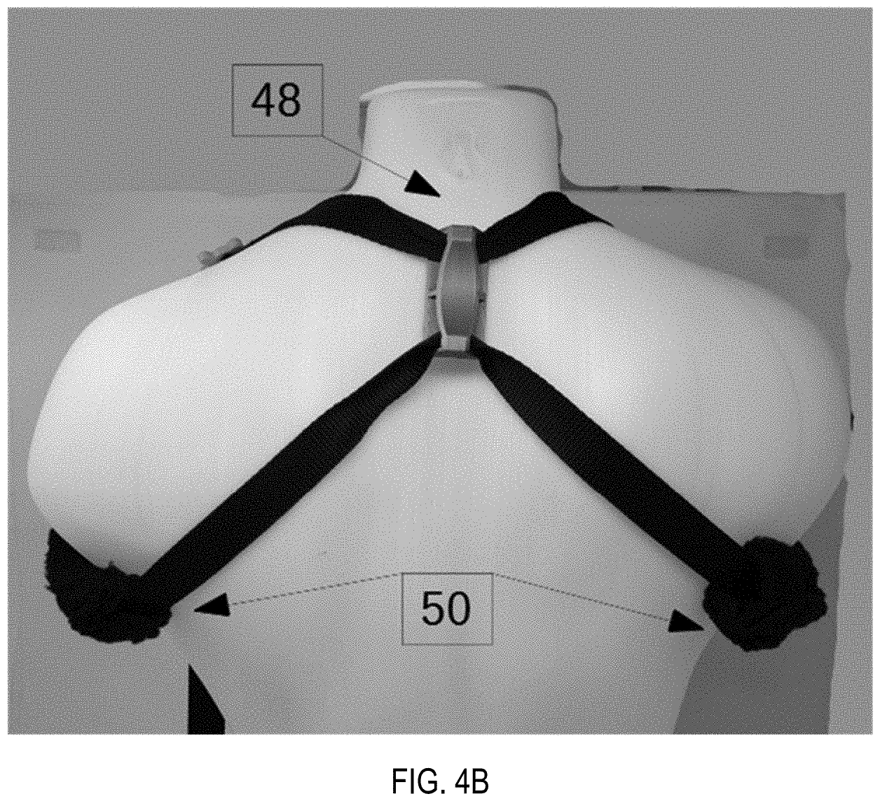

The extended reality arm stabilizer system 200 can be attached to a user body by wrapping around the shoulders and behind the back of the user. FIGS. 4A and 4B depict a completed strap pathing attached to a simulated user body.

A user may wear the extended reality arm stabilizer system as shown in FIGS. 4A, 4B, 5A, 5B, 7A, 7B, and 7C. In this example, the system 200 is shown on a right handed user. The user may reposition certain components of the system 200 to facilitate left handed use.

As an example, the user can fit and fix the system 200 to their torso by grabbing the strap portion of the strap 38 that has exited the lower portion of the strap adjuster 46 shown in FIG. 4A and pull downward to remove slack from the system 200 until the third point contact frame 202 is generally localized to the user's shoulder pocket 44 in as shown in FIG. 4A.

The system 200 may be worn similar to a backpack by looping around the shoulders, in between the arms and torso 50, and behind the back as shown in FIG. 4B. The rear strap conduit 48 in FIG. 4B does not have to be centered. The user may grab the strap adjuster and lift or pivot it upward to regain slack in the strap 38 and loosen the system 200.

The user may position the system 200 to be in a standby or ready position. A standby position may occur when the positional lever 26 is not acted upon by the user. This may result in the system 200 folding across the torso or hanging loosely depending on preference.

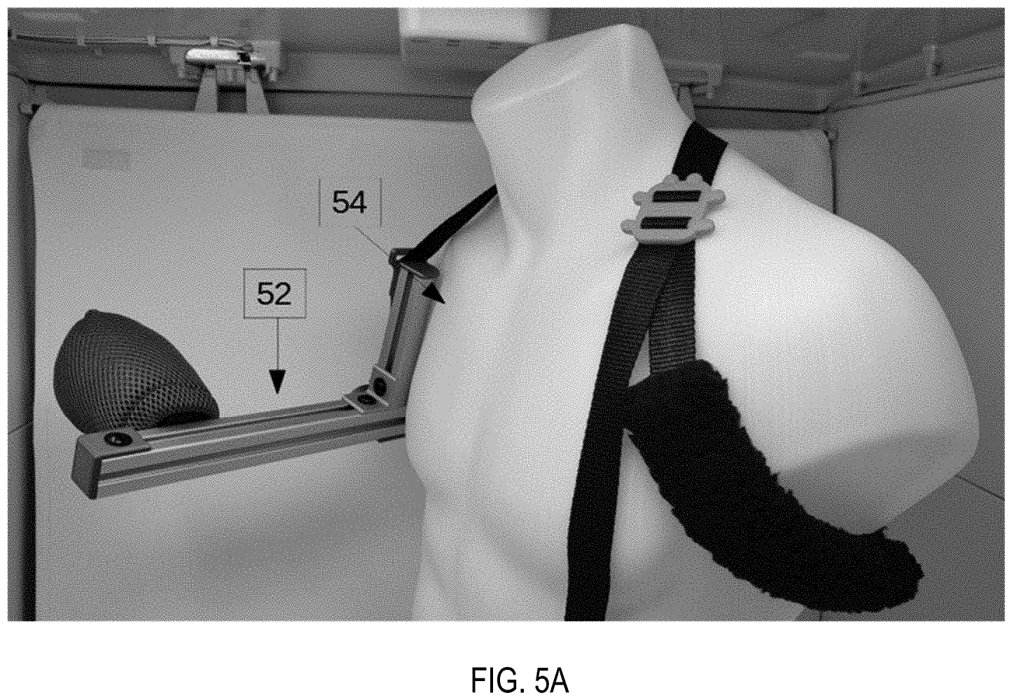

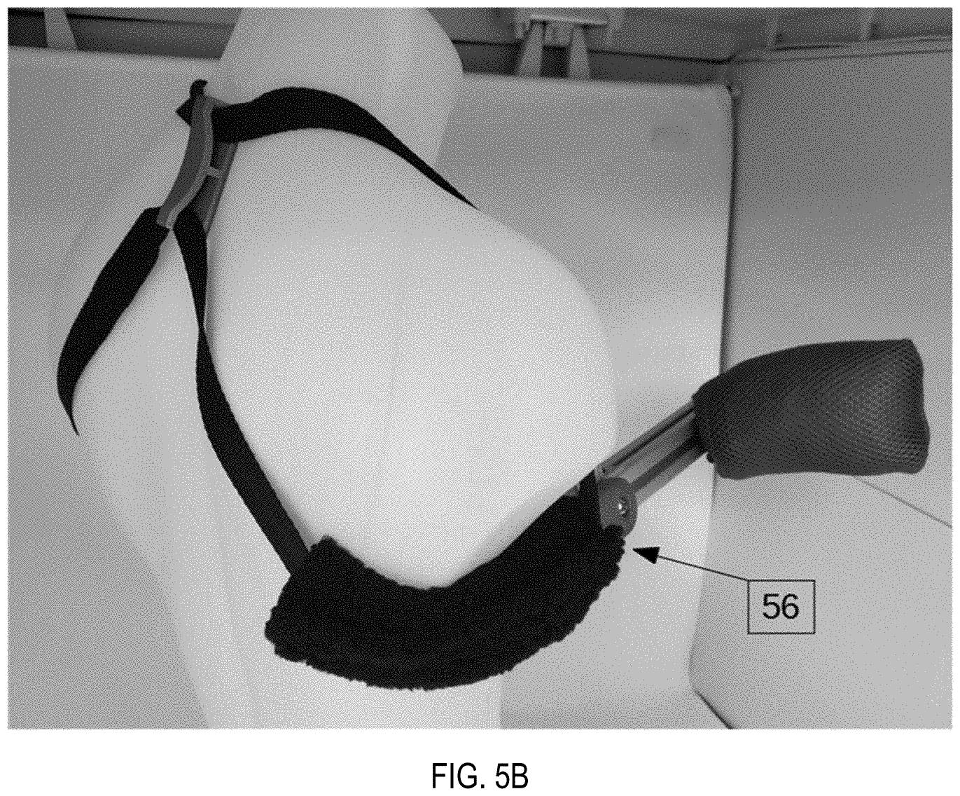

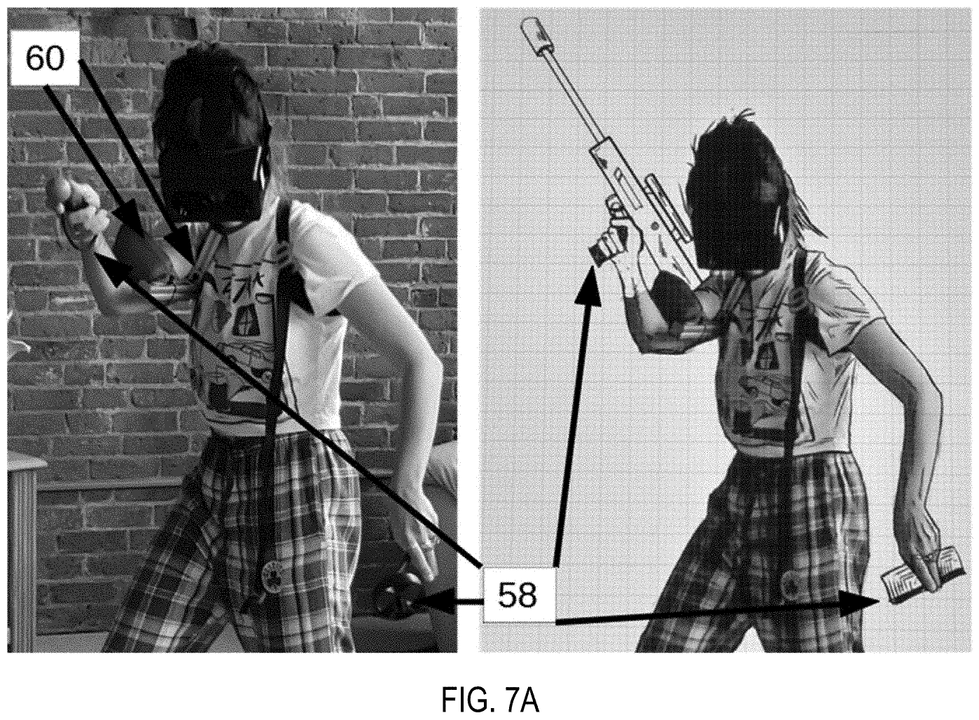

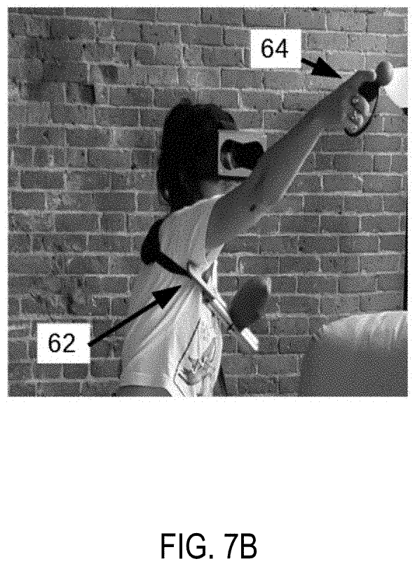

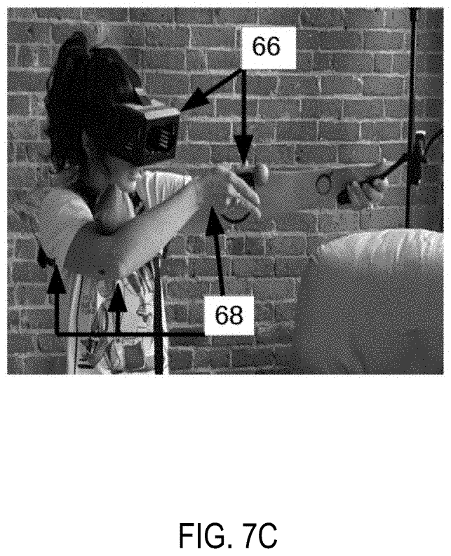

The positional states of the device are generally mediated by the positional lever 26. When the user has the positional lever 26 between their arm and torso, the system 200 can protrude outward. The user can engage the user arm interface 206 by raising their arm from below the system 200 as shown at points 52 and 54 in FIG. 5A. This is also shown in FIG. 7C. Optional strap padding can be placed around the positional lever 26 to simulate a ready position 56 as shown in FIG. 5B.

The user may transition from standby to a ready position with sweeping arm gestures that engage the positional lever 26 and place it between the arm and torso. The user may move their arm downward and engage the positional lever 26 back into a ready position as shown in FIG. 7B.

The user can be spatially aware of the system 200 and may engage a third point of contact with increased control because the system 200 can be worn and felt by the user.

Once the user engages their arm upon the user arm interface 204, the user may apply a force that is transferred through the third point contact frame 202 to the user's shoulder area 54 as shown in FIG. 5A and 60 in FIG. 7A. The user may also rest their hand or arm on the horizontal frame 24. Both actions can provide some arm stabilization and immersive haptic sensation.

The user can align their dominant eye for aiming 66 as shown in FIG. 7C while maintaining the third point of contact with intuitive adjustments of their shoulder, elbow, and/or wrist 68 in as shown in FIG. 7C.

The user may disengage the user arm interface 204 by moving their arm away from the system 200 to complete full range of motion mechanics 62, 64 as shown in FIG. 7B. Disengagement can be accomplished naturally. Thus, there may not be a magnetic or fixed connection between the controller and the system 200. The controllers do not have to be attached to the system 200 and the system does not necessitate controller specific adapters 58 as shown in FIG. 7A.

The system 200 provides the user an on-demand and user selected third point of contact that increases arm stabilization. This facilitates and steadies eye alignment in certain XR conditions. The user may also choose when to disengage the user arm interface 204 and perform full range of motion actions without overcoming fixed controller mechanisms. The user may perceive greater awareness of the device because it is touching their body and localized to a known area. The user conditionally interacts with the system 200.

The third point of contact does not have to connect the trigger arm with the shoulder pocket of a person. Alternative third points of contact may be the floor, ceiling, wall, or other fixture that is not attached to the body. In another example, a long pole may be connected to the user and the floor. In another example, the user may connect to an adjustable cable retraction system attached to the ceiling or wall. In another example, the user may connect to a counterweight system.

Alternative third points of contact may be connected to the user's bicep, shoulder, torso, core, hip, back, or leg and are not limited to the shoulder pocket.

Alternative examples may include single or multiple point sling setups that go around the neck or a shoulder. Another example may include attachment around the hip, core, across the chest, a leg, or both legs.

Alternative examples for fitting the device may include the use of VELCRO, zippers, buttons, snaps, hook-and-loop fasteners, swivel joints, and rib or slot-slide closures.

Alternative examples of the fixed angle bracket may include dynamic angle brackets with or without locking mechanisms.

Alternative examples of the fixed horizontal and vertical frame include variable length frames that may be achieved with telescoping, linear bearing mechanisms, and/or addition of fixed length hardware extensions. Extensions of the horizontal frame may be connected via dynamically pivoting joints that produce an angle between the two horizontal lengths.

In another example, a fixed or variable length cheek rest may be affixed to the vertical frame.

The shape and mount point of the user arm interface 204 is not limited to the shape or the mount point 36 shown in the FIGS. 2B and 2C. The user arm interface 204 may have a different shape such as straight or slightly curved so that the user places their arm upon, underneath, or beside the user arm interface 204. The user arm interface 204 may be hollow and enclose the user arm. Alternative enclosed user arm interfaces may range from hollow cylinders, hollow angled funnels, or hollow angled hourglass shapes. The user arm interface 204 also may be semi enclosed shapes such as U shapes, V shapes, C shapes, etc.

In another example, there may be more than one user arm interface 204. As an example, there may be a user arm interface 204 for both arms of a user. The arm user interface 204 may be used by either the left arm, right arm, or both arms. In these examples, a connection would be made between the first and fourth points of contact as well as the second and third points of contact. These examples might provide benefits similar to steering wheel and HOTAS controllers.

In further examples, the localization area and user arm interface may be the same or different for the user's left and/or right arms.

Other examples may also include additional ways to increase the user's spatial awareness of the system 200 with the use of guide lines. These examples may connect an adjustable cable retraction or counterweight system to the user's wrist, hand, and/or arm which would guide the user to the user arm interface 204. This would provide increased guidance to the system 200 without the aid of sight.

As noted above, the system 200 could also include multiple user arm interfaces 204 per device. In one example, the system 200 may have two user arm interfaces 204 that support a single arm. Alternatively, the system 200 may include two user arm interfaces 204 that interact with different arms. This may facilitate arm stabilization of the forward and trigger hands for the purpose of aiming. In these examples, the first and second points of contact would be connected to a third point of contact.

Other examples may incorporate mechanically adjustable joints within the device to facilitate three or more points of contact and arm stabilization.

In addition, the system 200 may incorporate electronically controlled joints within the device to facilitate three more points of contact and arm stabilization. As an example, the system 200 may incorporate voice activated controls in conjunction with electronically controlled joints within the device to facilitate three or more points of contact and arm stabilization. For example, the system 200 may provide user arm interfaces and three or more points of contact frames on both sides of the user's body for their left and/or right arms. The user may save game asset profiles for different positions to facilitate additional points of contact with the user's arms.

Electronically controlled mechanisms may change lengths, angles, user arm interface positions, and/or user arm interface angles to facilitate the user's preferred placements for a specific XR asset or software. For example, the user may have one or more preferred profiles for a shotgun, pistol, and rifle, among others. These additional mechanisms would assist in customizing user profiles for the purpose of arm stabilization in XR and would not affect the controllers.

In another example, the positional assistance systems may be applied to a single device for either the left and/or right side of the user.

The extended reality arm stabilizer system 200 may be in communication with at least one computing device via a communication network. The at least one computing device may be XR hardware, a server computing device, and/or client computing device having at least one processor and may have an application that may be used to monitor the real-time information from the system 200 and send commands to the system 200.

The communication network can be the Internet, an intranet, or another wired or wireless communication network. For example, the communication network may include a Mobile Communications (GSM) network, a code division multiple access (CDMA) network, 3^{rd} Generation Partnership Project (GPP) network, an Internet Protocol (IP) network, a wireless application protocol (WAP) network, a WiFi network, a Bluetooth network, a satellite communications network, or an IEEE 802.11 standards network, as well as various communications thereof. Other conventional and/or later developed wired and wireless networks may also be used.

FIG. 6A illustrates an example method 600 of using a conventional device according to an example of the instant disclosure. As shown in FIG. 6A, the conventional device has been very complicated and tedious to use. A user can attach controllers to specific adapters. In one example, the user may use under mount adapters to fixed or semi articulated hardware and adjust yaw/pitch as needed. Alternatively, the user can use over mount adapters to fixed or semi articulated hardware and adjust yaw/pitch as needed. Next, the user can put on an XR hardware headset and begin a game or software. The user can choose a game asset and test for eye alignment with a shoulder connection. This may continue for a long period of time and may result in continued inability to properly use the hardware or the controller(s). The user may lose eye alignment but maintain a shoulder connection, or the user may maintain eye alignment and lose a shoulder connection, or the user can continue with a limited range of motion and attempt to play the game or software. As shown in FIG. 6A, this is far less than ideal and there are numerous problems and drawbacks. In short, the user can spend more time setting up the game or software and the controller than actually using the game or software with the controller. The experience is lacking for many reasons.

FIG. 6B illustrates an example method 650 of use of the extended reality arm stabilizer system 200 according to an example of the instant disclosure. Although the example method 650 depicts a particular sequence of operations, the sequence may be altered without departing from the scope of the present disclosure. For example, some of the operations depicted may be performed in parallel or in a different sequence that does not materially affect the function of the method 650. In other examples, different components of an example device or system that implements the method 650 may perform functions at substantially the same time or in a specific sequence.

According to some examples, the method 650 includes a user wearing the system 200 and adjusting the system 200 for comfort at block 652. Next, the method 650 includes the user utilizing an XR headset, controllers, and starting associated software or a game at block 654. Next, the method 650 includes placing an arm into the system and adjusting an arm position with a wrist, elbow, or shoulder at block 656. This may provide a full range of motion for the user. The method 650 may include the user playing the game or software at block 658.

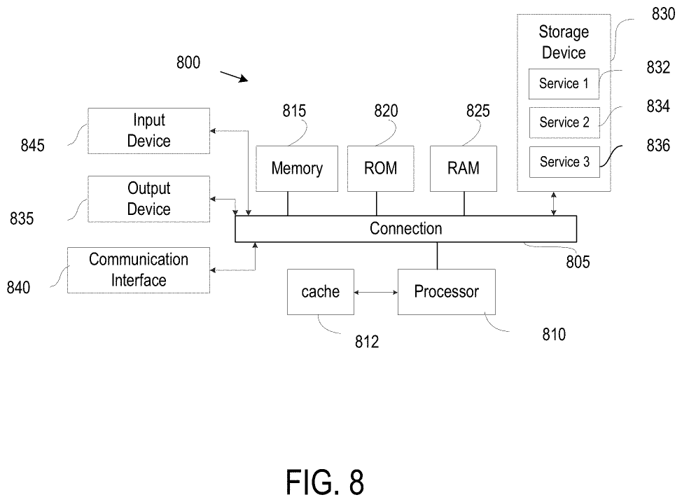

FIG. 8 shows an example of computing system 800, which can be for example any computing device making up the computing device such as the XR hardware, at least one server computing device, or at least one client computing device, or any component thereof in which the components of the system are in communication with each other using connection 805. Connection 805 can be a physical connection via a bus, or a direct connection into processor 810, such as in a chipset architecture. Connection 805 can also be a virtual connection, networked connection, or logical connection.

In some embodiments, computing system 800 is a distributed system in which the functions described in this disclosure can be distributed within a datacenter, multiple data centers, a peer network, etc. In some embodiments, one or more of the described system components represents many such components each performing some or all of the function for which the component is described. In some embodiments, the components can be physical or virtual devices.

Example system 800 includes at least one processing unit (CPU or processor) 810 and connection 805 that couples various system components including system memory 815, such as read-only memory (ROM) 820 and random access memory (RAM) 825 to processor 810.

Computing system 800 can include a cache of high-speed memory 812 connected directly with, in close proximity to, or integrated as part of processor 810.

Processor 810 can include any general purpose processor and a hardware service or software service, such as services 832, 834, and 836 stored in storage device 830, configured to control processor 810 as well as a special-purpose processor where software instructions are incorporated into the actual processor design. Processor 810 may essentially be a completely self-contained computing system, containing multiple cores or processors, a bus, memory controller, cache, etc. A multi-core processor may be symmetric or asymmetric.

To enable user interaction, computing system 800 includes an input device 845, which can represent any number of input mechanisms, such as a microphone for speech, a touch-sensitive screen for gesture or graphical input, keyboard, mouse, motion input, speech, etc. Computing system 800 can also include output device 835, which can be one or more of a number of output mechanisms known to those of skill in the art. In some instances, multimodal systems can enable a user to provide multiple types of input/output to communicate with computing system 800. Computing system 800 can include communications interface 840, which can generally govern and manage the user input and system output. There is no restriction on operating on any particular hardware arrangement, and therefore the basic features here may easily be substituted for improved hardware or firmware arrangements as they are developed.

Storage device 830 can be a non-volatile memory device and can be a hard disk or other types of computer readable media which can store data that are accessible by a computer, such as magnetic cassettes, flash memory cards, solid state memory devices, digital versatile disks, cartridges, random access memories (RAMs), read-only memory (ROM), and/or some combination of these devices.

The storage device 830 can include software services, servers, services, etc., that when the code that defines such software is executed by the processor 810, it causes the system to perform a function. In some embodiments, a hardware service that performs a particular function can include the software component stored in a computer-readable medium in connection with the necessary hardware components, such as processor 810, connection 805, output device 835, etc., to carry out the function.

For clarity of explanation, in some instances, the present technology may be presented as including individual functional blocks including functional blocks comprising devices, device components, steps or routines in a method embodied in software, or combinations of hardware and software.

Any of the steps, operations, functions, or processes described herein may be performed or implemented by a combination of hardware and software services or services, alone or in combination with other devices. In some embodiments, a service can be software that resides in memory of a client device and/or one or more servers of a content management system and perform one or more functions when a processor executes the software associated with the service. In some embodiments, a service is a program or a collection of programs that carry out a specific function. In some embodiments, a service can be considered a server. The memory can be a non-transitory computer-readable medium.

In some embodiments, the computer-readable storage devices, mediums, and memories can include a cable or wireless signal containing a bit stream and the like. However, when mentioned, non-transitory computer-readable storage media expressly exclude media such as energy, carrier signals, electromagnetic waves, and signals per se.

Methods according to the above-described examples can be implemented using computer-executable instructions that are stored or otherwise available from computer-readable media. Such instructions can comprise, for example, instructions and data which cause or otherwise configure a general purpose computer, special purpose computer, or special purpose processing device to perform a certain function or group of functions. Portions of computer resources used can be accessible over a network. The executable computer instructions may be, for example, binaries, intermediate format instructions such as assembly language, firmware, or source code. Examples of computer-readable media that may be used to store instructions, information used, and/or information created during methods according to described examples include magnetic or optical disks, solid-state memory devices, flash memory, USB devices provided with non-volatile memory, networked storage devices, and so on.

Devices implementing methods according to these disclosures can comprise hardware, firmware and/or software, and can take any of a variety of form factors. Typical examples of such form factors include servers, laptops, smartphones, small form factor personal computers, personal digital assistants, and so on. The functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are means for providing the functions described in these disclosures.

Illustrative examples of the disclosure include:

Aspect 1: A system comprising: a third point contact frame comprising a vertical frame and a horizontal frame connected with mounting hardware, the third point contact frame having a positional lever connected to one end of the horizontal frame closest to the vertical frame, a user arm interface having a first end and a second end opposite one another and connected with a middle bar, the user arm interface mounted to the third point contact frame, and a user attachment system configured to be worn by a user comprising a strap mounting bracket that is attached to the vertical frame of the third point contact frame, a strap pathed through a strap adjuster, the strap mounting bracket, and the positional lever.

Aspect 2: The system of Aspect 1, further comprising user arm interface padding and that encloses the user arm interface and strap padding attached to the strap.

Aspect 3: The system of Aspects 1 and 2, wherein the horizontal frame comprises aluminum and the positional lever comprises polylactic acid plastic.

Aspect 4: The system of Aspects 1 to 3, wherein the third point of contact frame is configured to contact at least one of a bicep of the user, a shoulder of the user, a torso of the user, a core of the user, a hip of the user, a back of the user, and a leg of the user.

Aspect 5: The system of Aspects 1 to 4, wherein the system is configured to fit the user attachment device to the user by using the strap adjuster.

Aspect 6: The system of Aspects 1 to 5, wherein the strap adjuster comprises one of a zipper, a button, a snap, a hook and loop fastener, a swivel joint, and a rib or slot-slide enclosure.

Aspect 7: The system of Aspects 1 to 6, wherein the system is configured for use with an extended reality controller.

Aspect 8: The system of Aspects 1 to 7, further comprising at least one processor to store a user profile in memory for the system.

Aspect 9: The system of Aspects 1 to 8, wherein the user profile is associated with a positional profile for at least one activity.

Aspect 10: The system of Aspects 1 to 9, wherein the user arm interface is configured to receive an arm of the user.

Aspect 11: The system of Aspects 1 to 10, wherein the user attachment system is configured to form a first loop to be worn on a first shoulder of the user and form a second loop to be worn on a second shoulder of the user.

Aspect 12: The system of Aspects 1 to 11, wherein the user arm interface comprises a first user arm interface and the system comprises a second user arm interface having a first end and a second end opposite one another and connected with a middle bar, the second user arm interface mounted to the third point contact frame.

Aspect 13: A method comprising, attaching a user attachment system to a user, the user attachment system comprising a strap mounting bracket that is attached to a vertical frame of a third point contact frame, a strap pathed through a strap adjuster, the strap mounting bracket, and a positional lever, and receiving an arm of the user into a user arm interface having a first end and a second end opposite one another and connected with a middle bar, the user arm interface mounted to a third point contact frame comprising a vertical frame and a horizontal frame connected with mounting hardware, and a positional lever connected to one end of the horizontal frame closest to the vertical frame.

Aspect 14: An arm stabilizer device for extended reality, comprising: a third point contact frame comprising a vertical frame and a horizontal frame connected with mounting hardware, the third point contact frame having a positional lever connected to one end of the horizontal frame closest to the vertical frame, a user arm interface having a first end and a second end opposite one another and connected with a middle bar, the user arm interface mounted to the third point contact frame, and a user attachment system configured to be worn by a user comprising a strap mounting bracket that is attached to the vertical frame of the third point contact frame, a strap pathed through a strap adjuster, the strap mounting bracket, and the positional lever.

Aspect 15: The device of Aspect 14, further comprising user arm interface padding and that encloses the user arm interface and strap padding attached to the strap.

Aspect 16: The device of Aspects 14 and 15, wherein the horizontal frame comprises aluminum and the positional lever comprises polylactic acid plastic.

Aspect 17: The device of Aspects 14 to 16, wherein the third point of contact frame is configured to contact at least one of a bicep of the user, a shoulder of the user, a torso of the user, a core of the user, a hip of the user, a back of the user, and a leg of the user.

Aspect 18: The device of Aspects 14 to 17, wherein the device is configured to fit the user attachment device to the user by using the strap adjuster.

Aspect 19: The device of Aspects 14 to 18, wherein the strap adjuster comprises one of a zipper, a button, a snap, a hook and loop fastener, a swivel joint, and a rib or slot-slide enclosure.

Aspect 20: The device of Aspects 14 to 19, wherein the user arm interface is configured to receive an arm of the user.

What is claimed is:

1. A system comprising:
a third point contact frame comprising a vertical frame and a horizontal frame connected with mounting hardware, the third point contact frame having a positional lever connected to one end of the horizontal frame closest to the vertical frame;
a user arm interface having a first end and a second end opposite one another and connected with a middle bar, the user arm interface mounted to the third point contact frame; and
a user attachment system configured to be worn by a user comprising a strap mounting bracket that is attached to the vertical frame of the third point contact frame, a strap pathed through a strap adjuster, the strap mounting bracket, and the positional lever.

2. The system of claim 1, further comprising:
user arm interface padding and that encloses the user arm interface and strap padding attached to the strap.

3. The system of claim 1, wherein the horizontal frame comprises aluminum and the positional lever comprises polylactic acid plastic.

4. The system of claim 1, wherein the third point of contact frame is configured to contact at least one of a bicep of the user, a shoulder of the user, a torso of the user, a core of the user, a hip of the user, a back of the user, and a leg of the user.

5. The system of claim 1, wherein the system is configured to fit the user attachment device to the user by using the strap adjuster.

6. The system of claim 5, wherein the strap adjuster comprises one of a zipper, a button, a snap, a hook and loop fastener, a swivel joint, and a rib or slot-slide enclosure.

7. The system of claim 1, wherein the system is configured for use with an extended reality controller.

8. The system of claim 1, further comprising at least one processor to store a user profile in memory for the system.

9. The system of claim 8, wherein the user profile comprises a positional profile for at least one activity.

10. The system of claim 1, wherein the user arm interface is configured to receive an arm of the user.

11. The system of claim 1, wherein the user attachment system is configured to form a first loop to be worn on a first shoulder of the user and form a second loop to be worn on a second shoulder of the user.

12. The system of claim 1, wherein the user arm interface comprises a first user arm interface and the system comprises a second user arm interface having a first end and a second end opposite one another and connected with a middle bar, the second user arm interface mounted to the third point contact frame.

13. A method, comprising:
attaching a user attachment system to a user, the user attachment system comprising a strap mounting bracket that is attached to a vertical frame of a third point contact frame, a strap pathed through a strap adjuster, the strap mounting bracket, and a positional lever; and
receiving an arm of the user into a user arm interface having a first end and a second end opposite one another and connected with a middle bar, the user arm interface mounted to a third point contact frame comprising a vertical frame and a horizontal frame connected with mounting hardware, and a positional lever connected to one end of the horizontal frame closest to the vertical frame.

14. An arm stabilizer device for extended reality, comprising:
a third point contact frame comprising a vertical frame and a horizontal frame connected with mounting hardware, the third point contact frame having a positional lever connected to one end of the horizontal frame closest to the vertical frame;
a user arm interface having a first end and a second end opposite one another and connected with a middle bar, the user arm interface connected to the third point contact frame; and
a user attachment system configured to be worn by a user comprising a strap mounting bracket that is attached to the vertical frame of the third point contact frame, a strap pathed through a strap adjuster, the strap mounting bracket, and the positional lever.

15. The device of claim 14, further comprising:
user arm interface padding and that encloses the user arm interface and strap padding attached to the strap.

16. The device of claim 14, wherein the horizontal frame comprises aluminum and the positional lever comprises polylactic acid plastic.

17. The device of claim 14, wherein the third point of contact frame is configured to contact at least one of a bicep of the user, a shoulder of the user, a torso of the user, a core of the user, a hip of the user, a back of the user, and a leg of the user.

18. The device of claim 14, wherein the device is configured to fit the user attachment device to the user by using the strap adjuster.

19. The device of claim 18, wherein the strap adjuster comprises one of a zipper, a button, a snap, a hook and loop fastener, a swivel joint, and a rib or slot-slide enclosure.

20. The device of claim 14, wherein the user arm interface is configured to receive an arm of the user.
